(19) United States
(12) Patent Application Publication
(10) Pub. No.: US 2026/0089275 A1
(43) Pub. Date: Mar. 26, 2026

(54) IMAGE PROCESSING APPARATUS, CONTROL METHOD, AND NON-TRANSITORY COMPUTER-READABLE RECORDING MEDIUM

(71) Applicant: Konica Minolta, Inc., Tokyo (JP)

(72) Inventor: Hiroshi UGA, Tokyo (JP)

(21) Appl. No.: 19/337,255

(22) Filed: Sep. 23, 2025

(30) Foreign Application Priority Data
Sep. 26, 2024 (JP) 2024-166957

(51) Int. Cl. H04N 1/00; H04N 1/44

(52) U.S. Cl. CPC H04N 1/00514; H04N 1/00432; H04N 1/00474; H04N 1/00482; H04N 1/4413; H04N 1/4433; H04N 2201/0094

(57) ABSTRACT

An image processing apparatus, comprises a hardware processor and a display part that displays a plurality of display areas assigned to respective users, and arranges and displays operation keys associated with jobs in the respective display areas. The hardware processor registers and manages, for each user, a setting value of a setting item to be applied to a job. When the operation key in any one of the plurality of display areas is operated, the hardware processor identifies a user based on the display area in which the operation key is operated, reads the setting value registered for the identified user, and reflects the setting value as an initial value of the setting item to be applied to the job.

### CROSS REFERENCE TO RELATED APPLICATIONS

The present application is based on Japanese Patent Application No. 2024-166957 filed on Sep. 26, 2024, the contents of which are incorporated herein by reference.

### BACKGROUND OF THE INVENTION

### Technical Field

The present invention relates to an image processing apparatus, a control method, and a non-transitory computer-readable recording medium.

### Description of Related Art

The shared office is an office in which a plurality of companies share a single office space. An image processing apparatus such as an MFP (Multifunction Peripheral) may be installed in such a shared office. In this case, one image processing apparatus is commonly used by users of a plurality of companies. However, in a case where one image processing apparatus is shared by a plurality of companies, it may be required to apply a unique setting value for each company or to limit the function of the image processing apparatus.

In the related art, an image processing apparatus has been proposed in which a range in which a user can change settings when using the image processing apparatus is registered for each user or group (for example, Japanese Unexamined Patent Publication No. JP2021-158411A). In this conventional technology, the image processing apparatus is equipped with an authentication function such as card authentication. The image processing apparatus can identify an individual user through user authentication by the authentication function and determine to which company the identified user belongs. Therefore, when the image processing apparatus transitions to the logged in state by user authentication, the image processing apparatus can automatically reflect setting values and the like unique to the company to which the identified user belongs.

However, an image processing apparatus to be installed in the shared office may not be able to install an authentication function for identifying an individual user due to problems such as introduction cost. When the image processing apparatus is installed in an environment in which the authentication function cannot be introduced, it is difficult for the image processing apparatus to reflect and display a unique setting value or the like for each company or user.

### SUMMARY OF THE INVENTION

The present invention has been devised in order to solve the above-described problems. That is, an object of the present invention is to provide an image processing apparatus, a control method, and a program which can reflect and display setting values and the like unique to each company or user by a relatively simple method, thereby enhancing user convenience.

A first subject of the present invention is directed to an image processing apparatus.

According to an aspect of the first subject, an image processing apparatus includes a hardware processor and a display part that displays a plurality of display areas assigned to respective users and arranges and displays operation keys associated with jobs in the respective display areas. The hardware processor registers and manages, for each user, a setting value of a setting item to be applied to a job. When the operation key in any one of the plurality of display areas is operated, the hardware processor identifies a user based on the display area in which the operation key is operated, reads the setting value registered for the identified user, and reflects the setting value as an initial value of the setting item to be applied to the job.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating an example of an external configuration of an image processing apparatus;

FIG. 2 is a diagram illustrating an example of a hardware configuration of an image processing apparatus;

FIG. 3 is a diagram illustrating an example of an operation screen displayed on the display part;

FIG. 4 is a block diagram illustrating a functional configuration of a setting management section;

FIGS. 5A and 5B are diagrams illustrating an example of an operation screen in which a plurality of display areas are set;

FIG. 6 is a diagram illustrating an example of a setting screen for registering setting values of various setting items applied to a copy job;

FIG. 7 is a diagram illustrating an example of setting value information;

FIG. 8 is a flowchart illustrating a processing procedure for registering a unique setting value for each of users belonging to different companies;

FIG. 9 is a flowchart illustrating a processing procedure for automatically reflecting a setting value when a user uses the image processing apparatus;

FIG. 10 is a diagram illustrating an example of initial values to be reflected in an application in response to an operation key operated by a user;

FIGS. 11A and 11B are diagrams illustrating operation screens in which a plurality of display areas are set as tab screens;

FIG. 12 is a block diagram illustrating an example of the detailed configuration of a setting management section in the second embodiment;

FIG. 13 is a diagram illustrating a screen example for setting an authentication password by an authentication unit;

FIG. 14 is a block diagram illustrating an example of the detailed configuration of the setting management section in the third embodiment;

FIG. 15 is a diagram illustrating an example of setting value information to which an item of function restriction has been added;

FIG. 16 is a diagram illustrating an example of destination information to which display restriction is applied; and

FIG. 17 is a diagram illustrating a display example of a destination list which changes according to an operation key operated by a user.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### First Embodiment

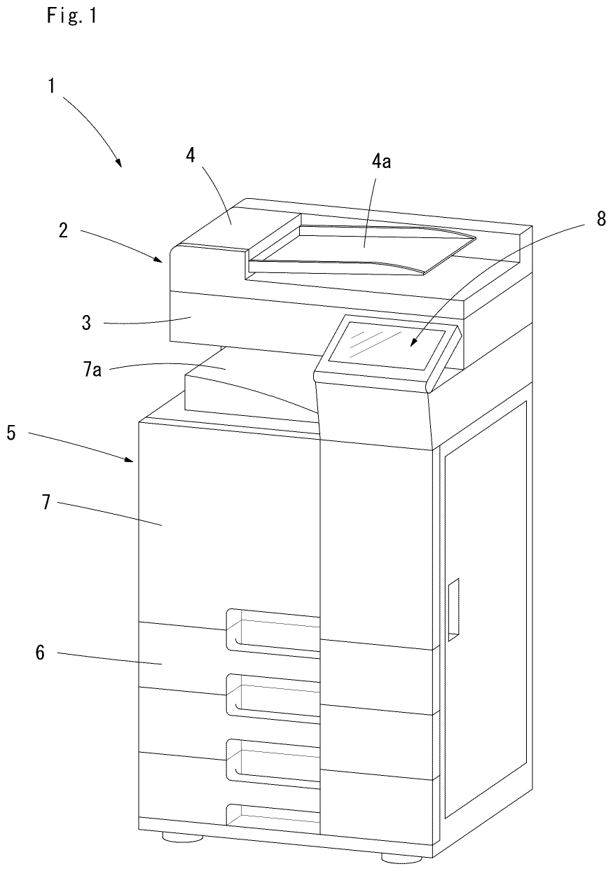

FIG. 1 is a diagram illustrating an example of an external configuration of an image processing apparatus 1 according to an embodiment of the present invention. The image processing apparatus 1 is configured as, for example, an MFP, and has a plurality of functions such as a copy function, a scan function, and a print function. The image processing apparatus 1 executes a copy job, a scan job, or a print job based on an instruction from a user. The image processing apparatus 1 is connected to a network such as a LAN (not illustrated). Therefore, the image processing apparatus 1 can transmit image data generated by executing a scan job to an external apparatus via a network. The image processing apparatus 1 is also capable of receiving a job such as a print job via the network.

For example, the image processing apparatus 1 is installed in an office such as a shared office that is shared by a plurality of companies or organizations. Therefore, the image processing apparatus is commonly used by users belonging to a plurality of companies.

The image processing apparatus 1 includes a scanner unit 2 in an upper portion of the apparatus body. The scanner unit 2 operates when a copy job or a scan job is executed in the image processing apparatus 1. The scanner unit 2 includes an image reading section 3 and an automatic document feeder (ADF) 4. The automatic document feeder 4 includes a document tray 4a on which a document is placed. The scanner unit 2 drives the automatic document feeder 4 to convey documents placed on a document tray 4a one by one. The scanner unit 2 drives the image reading section 3 in synchronization with the document conveying operation, reads an image of the document when the document passes through a predetermined image reading position, and generates image data.

The image processing apparatus 1 includes a printer unit 5 in a lower portion of the apparatus body. The printer unit 5 operates when a copy job or a print job is executed in the image processing apparatus 1. The printer unit 5 includes a sheet feed and conveyance section 6 and an image forming section 7. The sheet feed and conveyance section 6 conveys sheets such as printing sheet accommodated in a sheet feed cassette one by one. The image forming section 7 forms an image on a front surface of the sheet when the sheet conveyed by the sheet feed and conveyance section 6 passes through a predetermined position, and discharges the sheet to a sheet ejection tray 7a provided above the printer unit 5.

Furthermore, the image processing apparatus 1 includes an operation panel 8 on a front surface side of the apparatus main body. The operation panel 8 is a user interface for a user to use the image processing apparatus 1. The operation panel 8 includes, for example, a touch screen. When using the copy function or the scan function of the image processing apparatus 1, a user can make job settings by operating the operation panel 8. In addition, a user can give an instruction to execute a job to the image processing apparatus 1 by operating the operation panel 8.

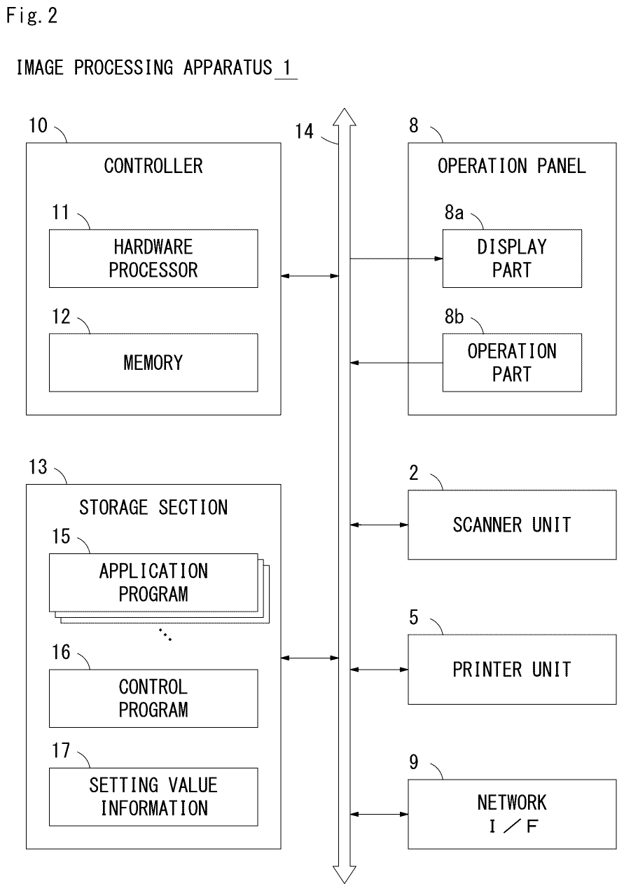

FIG. 2 is a diagram illustrating an exemplary hardware configuration of the image processing apparatus 1. As described above, the image processing apparatus 1 includes the scanner unit 2, the printer unit 5, and the operation panel 8. The operation panel 8 includes a display part 8a and an operation part 8b. The display part 8a includes, for example, a color liquid crystal display, and displays various operation screens that can be operated by a user. The operation part 8b detects a user's operation on an operation screen displayed on the display part 8a. For example, the operation part 8b includes touch screen keys arranged on the screen of the display part 8a.

The image processing apparatus 1 includes a network interface 9. The network interface 9 is an interface that connects the image processing apparatus 1 to a network and communicates with an external apparatus.

The image processing apparatus 1 includes a controller 10. The controller 10 comprehensively controls the operation of the image processing apparatus 1. The controller 10 includes a hardware processor 11 and a memory 12. The hardware processor 11 is, for example, a processor such as a central processing unit (CPU), and executes various computer-readable programs. The memory 12 is a volatile storage device that stores temporary data and the like generated by the hardware processor 11 executing the program.

Furthermore, the image processing apparatus 1 includes a storage section 13. The storage section 13 is a non-volatile storage device including a hard disk drive (HDD), a solid state drive (SSD), or the like. The storage section 13 stores various programs to be executed by the hardware processor 11 of the controller 10.

For example, the storage section 13 stores a plurality of application programs 15. The application program 15 is a program for activating an application for causing the image processing apparatus 1 to execute a job in the hardware processor 11 of the controller 10. The plurality of application programs 15 activate applications for causing the image processing apparatus 1 to execute different jobs. For example, one application program 15 activates an application for causing the image processing apparatus 1 to execute a copy job by using the copy function of the image processing apparatus 1. The other application program 15 uses the scanning function of the image processing apparatus 1 to activate an application that causes the image processing apparatus 1 to execute a scanning job.

Further, the plurality of application programs 15 include a program that uses the same function of the image processing apparatus 1. For example, one application program 15 activates an application for executing a process of storing image data generated by a scan job in the storage section 13 by using the scan function of the image processing apparatus 1. The other application program 15 uses the scan function of the image processing apparatus 1 to activate an application for executing a process of attaching image data generated by a scan job to an electronic mail and transmitting the electronic mail to the outside. Still another application program 15 activates an application for executing a process of transmitting image data generated by a scan job to an external apparatus via a network by using the scan function of the image processing apparatus 1. As described above, the plurality of application programs 15 include programs for executing different jobs using the same function of the image processing apparatus 1.

Further, the storage section 13 stores a control program 16. The control program 16 is executed by the hardware processor 11 and controls the operation at the time of activation of the application program 15. The control program 16 is, for example, a program that is incorporated into an operating system (OS), which is basic software of the image processing apparatus 1, as a partial function of the OS. However, the control program 16 may not be a program installed in the operating system. For example, the control program 16 may be an application program that is activated separately from the operating system and is resident in the controller 10.

The control program 16 is a program for giving a characteristic function of the present invention to the image processing apparatus 1. That is, even in a case where the image processing apparatus 1 is not equipped with an authentication function for identifying a user, the control program 16 performs control so as to reflect a unique setting value or the like for each user and display the setting value on the display part 8a. Specific functions and operations realized by the hardware processor 11 executing the control program 16 will be described later.

Further, the storage section 13 stores setting value information 17. The setting value information 17 is information in which unique setting values and the like are recorded for each company or each user who uses the image processing apparatus 1. Details of the setting value information 17 will be described later.

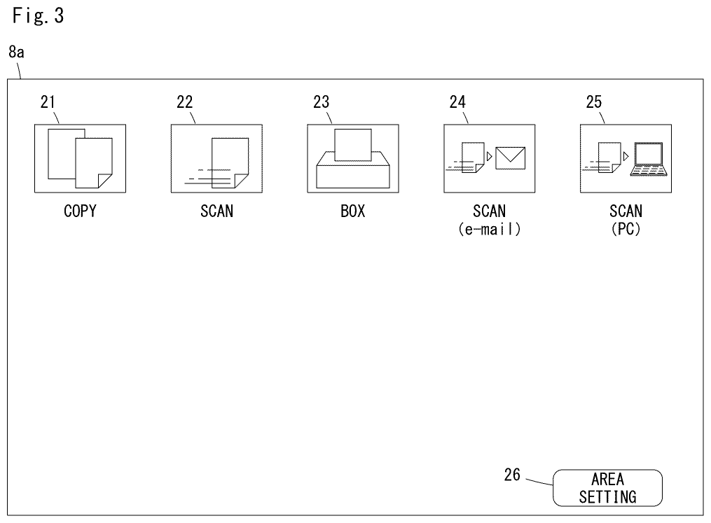

FIG. 3 is a diagram illustrating an example of an operation screen displayed on a display part 8a of the operation panel 8. The operation screen illustrated in FIG. 3 is, for example, a default screen which is set at the time of shipment of the image processing apparatus 1, and indicates a home screen which is displayed on the display part 8a immediately after the image processing apparatus 1 is powered on. The default home screen is, for example, a screen displayed on the display part 8a by the operating system of the image processing apparatus 1. On the default home screen, a plurality of operation keys 21 to 26 that can be operated by the user are displayed. For example, the operation keys 21 to 25 are shortcut keys for activating each of the plurality of application programs 15. The operation key 26 is a key for operating the function of the control program 16 resident in the controller 10.

In the operation key 21, a shortcut for activating an application that causes the image processing apparatus 1 to execute a job related to the copy function is registered in advance. In the operation keys 22, 24, and 25, a shortcut for activating an application that causes the image processing apparatus 1 to execute a job related to the scan function is registered in advance. Different application programs 15 are associated with the operation keys 22, 24, and 25, respectively. In the operation key 23, a shortcut for activating an application that causes the image processing apparatus 1 to execute a job related to the box function is registered in advance. The box function is a function of storing data in a predetermined storage area set in the storage section 13 and reading data stored in a predetermined storage area.

When any of the plurality of operation keys 21 to 25 is operated by a user, the hardware processor 11 executes the application program 15 corresponding to the operated operation key. Thus, the application specified by the user is activated in the controller 10. The application displays a job setting screen on the display part 8a and receives a job setting operation by the user. When displaying the setting screen of the job, the application reflects the initial value held in the application to each setting item of the setting screen. The initial values of the setting items stored in the application are common to a plurality of companies and users. For this reason, in a case where the operation keys 21 to 25 of the home screen are operated by the user, the display part 8a displays the setting screen of the job in a state where the initial values common to a plurality of companies or users are reflected. In this case, the job setting screen displayed on the display part 8a does not become a screen in which setting values unique to each user are reflected.

On the other hand, the control program 16 performs control such that a screen on which a unique setting value is reflected is displayed on the display part 8a for each user belonging to a different company. Functions of the control program 16 will be described in detail below.

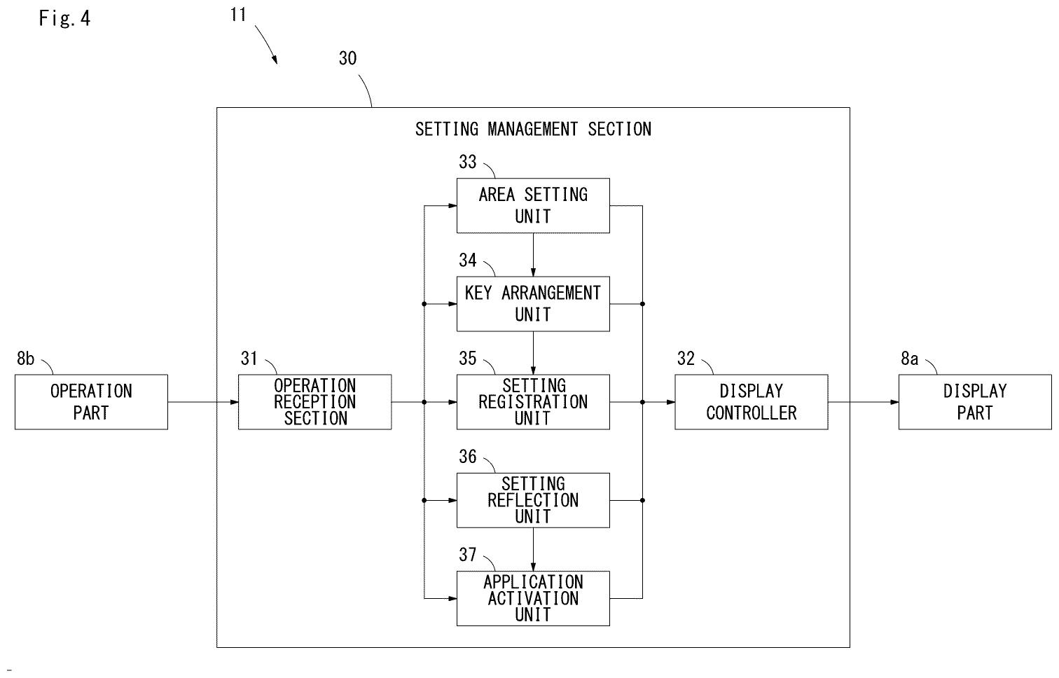

FIG. 4 is a block diagram illustrating a setting management section 30 that functions when the control program 16 is executed. The setting management section 30 is resident in the hardware processor 11 when the image processing apparatus 1 is powered on. The setting management section 30 includes an operation reception section 31, a display controller 32, an area setting unit 33, a key arrangement unit 34, a setting registration unit 35, a setting reflection unit 36, and an application activation unit 37.

The operation reception section 31 accepts a user's operation on the operation part 8b. For example, the operation reception section 31 receives, from the operation part 8b, coordinate information indicating an operation position of the user on the operation screen. The operation reception section 31 specifies the user's operation based on the coordinate information.

The display controller 32 controls an operation screen to be displayed on the display part 8a. For example, immediately after the image processing apparatus 1 is powered on, the display controller 32 displays the home screen on the display part 8a.

The area setting unit 33 sets, on the operation screen of the display part 8a, a display area to be assigned to each user. For example, when the operation key 26 (see FIG. 3) displayed on the home screen is operated by the user, the area setting unit 33 creates a display area assigned to the user on the operation screen of the display part 8a. For example, the display area is created as a folder in which operation keys designated by the user can be arranged and displayed. Further, the area setting unit 33 assigns a name designated by the user to the display area created on the operation screen. When the display area is created by the area setting unit 33, the display controller 32 displays the display area on the operation screen displayed on the display part 8a.

The key arrangement unit 34 arranges the operation keys in the display area created by the area setting unit 33. For example, when the user drags and drops one of the operation keys 21 to 25 displayed on the home screen to the display area, the key arrangement unit 34 places the operation key operated by the user inside the display area.

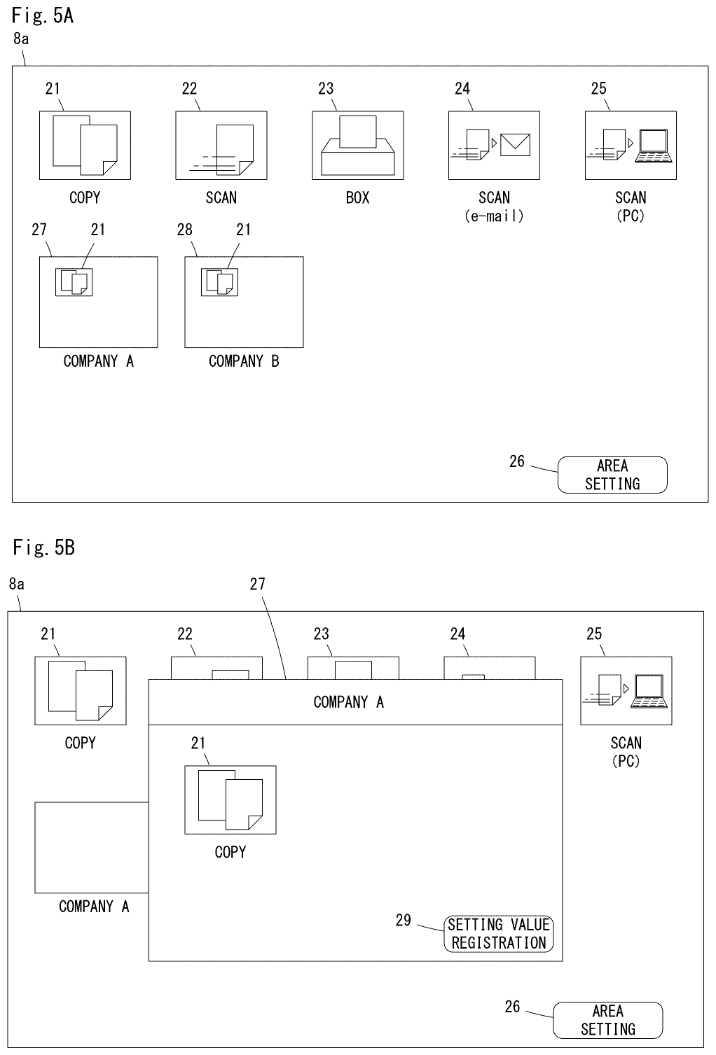

FIGS. 5A and 5B illustrate operation screens in which a plurality of display areas 27 and 28 are set. The operation screen of FIG. 5A shows a state in which two display areas 27 and 28 are created for the home screen. For example, the display area 27 is a folder created by a user belonging to a company A. The display area 27 is provided with “Company A” as a folder name. The display area 28 is a folder created by a user belonging to the company B. The display area 28 is provided with “Company B” as a folder name. In each of these display areas 27 and 28, the operation key 21 associated with the copy job are arranged. The display areas 27 and 28 displayed on the home screen are displayed as folders. Therefore, the operation key 21 arranged in the respective display areas 27 and 28 are displayed as thumbnail images.

When a user belonging to the company A wants to use the image processing apparatus 1 to perform a copy job, the user selects the display area 27 in the display part 8a. FIG. 5B illustrates an operation screen in a case where the display area 27 is selected by a user belonging to the company A. When the display area 27 is selected by the user, as illustrated in the 5B of the figure, the folder corresponding to the display area 27 is displayed in an enlarged manner on the front side of the home screen. Next, the operation key 21 arranged in the display area 27 are displayed as normal size key images. When the display area 27 is enlarged in the display part 8a, a setting value registration key 29 is displayed in the display area 27 in addition to the operation key 21 arranged by the user. The setting value registration key 29 is a key for registering, for each user, a setting value of a setting item to be applied to a job when the operation key 21 arranged in the display area 27 are operated. Note that FIG. 5B illustrates the case where the display area 27 is enlarged and displayed in the display part 8a, and the same applies to the case where the display area 28 is enlarged and displayed.

The user belonging to the company A operates the operation key 21 or the setting value registration key 29 with the display area 27 being displayed in an enlarged manner in the display part 8a. In addition, the user belonging to the company B operates the operation key 21 or the setting value registration key 29 in a state where the display area 28 is enlarged and displayed on the display part 8a.

When the setting value registration key 29 is operated by the user, a setting registration unit 35 comes into effect in the setting management section 30. The setting registration unit 35 registers and manages a unique setting value for each of the operation keys 21 arranged in the display areas 27 and 28. For example, when the setting value registration key 29 in the display area 27 is operated, the setting registration unit 35 registers and manages the set value of the setting item to be applied to the job when the operation key 21 in the display area 27 is operated. On the operation screen illustrated in the 5B of the figure, the operation key 21 associated with a copy job is arranged in the display area 27 corresponding to the company A. Therefore, when the setting value registration key 29 is operated by a user belonging to the company A, the setting registration unit 35 displays, on the display part 8a, a setting screen for registering setting values of various setting items to be applied to a copy job.

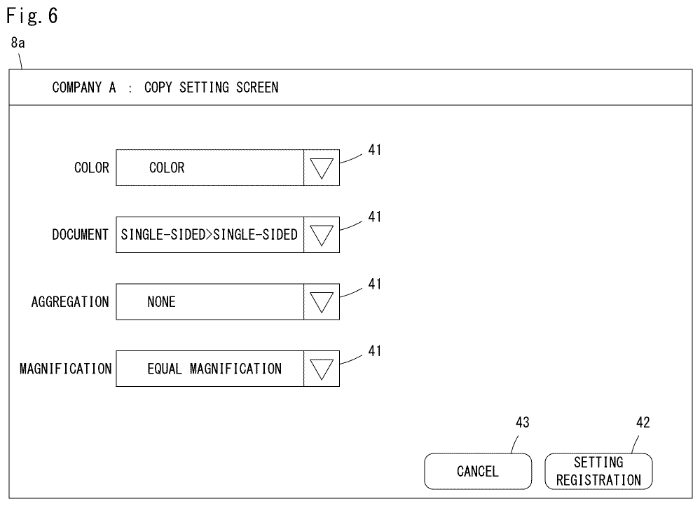

FIG. 6 is a diagram illustrating an example of a setting screen for registering setting values of various setting items applied to a copy job. For example, this setting screen is the same as a screen for performing a setting operation related to a job in a case where an application that executes a copy job is activated. On the setting screen illustrated in FIG. 6, four setting items of color, document, aggregation, and magnification are displayed as setting items applied to a copy job. The setting item of color is a setting item in which one setting value can be selected from two setting value groups of “color” and “monochrome”. The setting item of the document is a setting item in which one setting value can be selected from four setting value groups of “single-sided [symbol] single-sided”, “single-sided [symbol] double-sided”, “double-sided [symbol] single-sided”, and “double-sided [symbol] double-sided”. The setting item of aggregation is a setting item for which one setting value can be selected from a plurality of setting value groups such as “none”, “2in1”, and “4in1”. Further, the magnification setting item is a setting item for which one setting value can be selected from a plurality of setting value groups such as “equal magnification (100%)”, “70%”, “86%”, “122%”, and “141%”.

The setting values set for the four setting items in the setting screen in FIG. 6 are reflected in an application associated with the operation key 21 as initial values when the application is activated. For each setting item, a pull-down key 41 for changing a setting value is displayed. When the pull-down key 41 is operated by the user, a pull-down menu for changing the setting value of the setting item is displayed on the setting screen. In the pull-down menu, a list of setting value groups including a plurality of setting values selectable as initial values by the user in each setting item is displayed. The user can set an initial value at the time of application activation by selecting a desired setting value from the pull-down menu.

Further, a setting registration key 42 and a cancel key 43 are displayed on the setting screen. The setting registration key 42 is a key for registering a setting value of each setting item selected by a user as an initial value at the time of starting an application. A cancel key 43 is a key for ending the display of the setting screen without registering the initial value at the time of starting the application.

When the setting registration key 42 is operated by the user, the setting registration unit 35 registers, in the setting value information 17, the setting value of each setting item selected by the user on the setting screen in FIG. 6. Therefore, the setting values recorded in the setting value information 17 can be arbitrarily rewritten by the user. Note that when the cancel key 43 is operated by the user, the setting registration unit 35 does not register the setting value of each setting item on the setting screen in the setting value information 17.

For example, the user belonging to the company A enlarges and displays the display area 27 of the company A and operates the setting value registration key 29 to display the setting screen of FIG. 6 on the display part 8a. The user of the company A performs an operation on the setting screen to set initial values at the time of starting the application. In this case, the setting registration unit 35 registers the setting value designated by the user of the company A in the setting value information 17 as the initial value of the user belonging to the company A.

Further, for example, the user belonging to the company B enlarges and displays the display area 28 of the company B and operates the setting value registration key 29 to display the setting screen of FIG. 6 on the display part 8a. The user of the company B performs an operation on the setting screen to set initial values at the time of activating the application. At this time, the user of the company B can set an initial value different from that of the user of the company A. Next, the setting registration unit 35 registers, in the setting value information 17, the setting value specified by the user of the company B as an initial value for the user belonging to the company B.

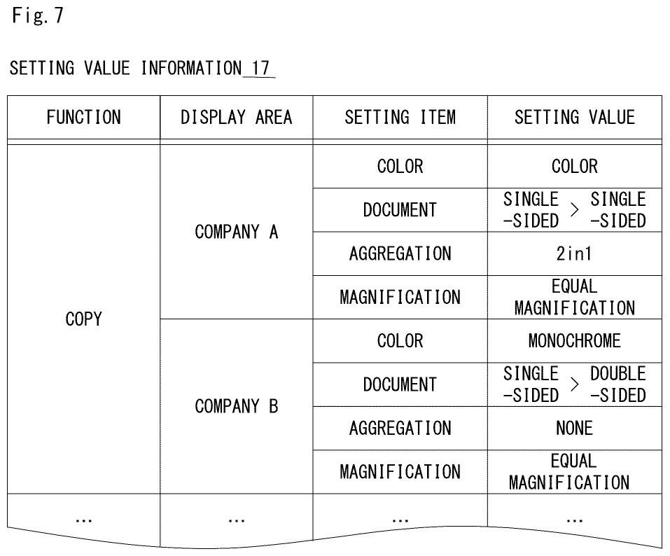

FIG. 7 is a view illustrating an example of the setting value information 17. The setting value information 17 is information in which a setting value of a setting item to which a job corresponding to each function of the image processing apparatus 1 is applied is registered for each user belonging to each of a plurality of companies. For example, as illustrated in FIG. 7, the setting value information 17 is information in which the setting value selected by the user of each of the companies A and B is registered for each user in each setting item applied to the job. The setting registration unit 35 stores and manages the setting value information 17 as illustrated in FIG. 7 in the storage section 13. Such setting value information 17 is managed as information different from the initial value that the application holds therein.

When the users belonging to the companies A and B register the setting values as described above, the setting management section 30 can reflect the setting values individually set for each user at the time of starting the application. As an example, a case will be described in which a user of the company A enlarges the display area 27 and operates the operation key 21 related to a copy job arranged in the display area 27. When the operation key 21 arranged in the display area 27 is operated by the user, a setting reflection unit 36 functions in the setting management section 30.

When the operation key 21 is operated, the setting reflection unit 36 specifies the display area 27 in which the operation key 21 is arranged, and specifies the user of the company A. The setting reflection unit 36 reads the setting value information 17 and reads a setting value designated in advance by the specified user from the setting value information 17. Then, the setting reflection unit 36 instructs the application activation unit 37 to activate the application.

The application activation unit 37 reads the application program 15 associated with the operation key 21 from the storage section 13 and executes the application program 15 to activate the application corresponding to the operation key 21. When the application is activated by the application activation unit 37, the setting reflection unit 36 overwrites the setting value of each setting item applied to the application with the setting value read from the setting value information 17. Thus, the application is activated in a state where the setting value specified in advance by the user of the company A is reflected as an initial value. That is, the user does not needs to change the setting value of each setting item to a setting value defined by the user's own company after starting up the application. Therefore, the operation load when the user uses the image processing apparatus 1 is reduced, and the convenience of the image processing apparatus 1 is improved.

When the user belonging to the company B uses the image processing apparatus 1, the user operates the operation key 21 arranged in the display area 28, whereby the same processing as described above is performed in the image processing apparatus 1.

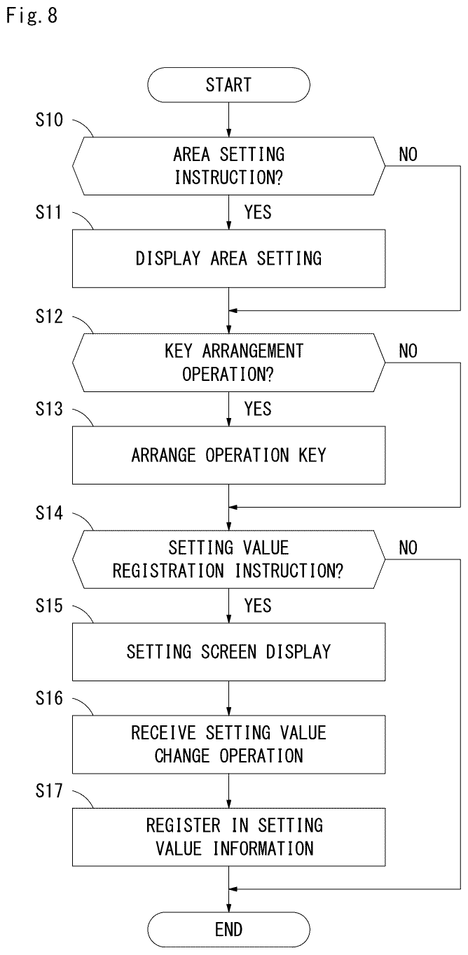

Next, a processing procedure of the image processing apparatus 1 will be described. FIG. 8 is a flowchart illustrating a processing procedure for registering a unique setting value for each of users belonging to different companies. This processing is performed by the area setting unit 33, the key arrangement unit 34, and the setting registration unit 35 in the setting management section 30 functioning.

When starting the processing of the flowchart illustrated in FIG. 8, the setting management section 30 first determines whether a region setting instruction from the user has been detected (step S10). For example, when the operation key 26 (see FIG. 3) is operated by the user, the setting management section 30 detects the area setting instruction by the user. When the area setting instruction is detected (YES in step S10), the setting management section 30 sets a new display area 27 or 28 in the operation screen displayed on the display part 8a (step S11). At this time, the setting management section 30 assigns the name designated by the user to the new display area 27 or 28. As a result, the operation screen displayed on the display part 8a is updated to a screen displaying the display area 27 or 28 set by the user, as shown in FIG. 5A.

Next, the setting management section 30 determines whether an operation of arranging the operation key 21 in the display area 27 or 28 is detected (step S12). When the operation of arranging the operation key 21 is detected (YES in step S12), the setting management section 30 arranges the operation key 21 designated by the user in the display area 27 or 28 designated by the user, and updates the operation screen (step S13).

Next, the setting management section 30 determines whether operation of the setting value registration key 29 has been detected (step S14). When the operation of the setting value registration key 29 is detected (YES in step S14), the setting management section 30 displays a setting screen as shown in FIG. 6 on the display part 8a (step S15). The setting management section 30 receives a setting value change operation performed by the user on the setting screen (step S16), registers the setting value specified by the user in the setting value information 17, and updates the setting value information 17 (step S17).

The setting management section 30 repeatedly performs the above-described process based on an operation performed by a user belonging to each of a plurality of companies. As a result, on the display part 8a of the operation panel 8, a plurality of display area 27 and 28 assigned to each user are displayed, and the operation key 21 associated with the job are displayed in a state of being arranged in each of the plurality of display areas 27 and 28. The setting management section 30 registers, for each user, setting values of setting items to be applied to a job in the setting value information 17 and manages the setting values.

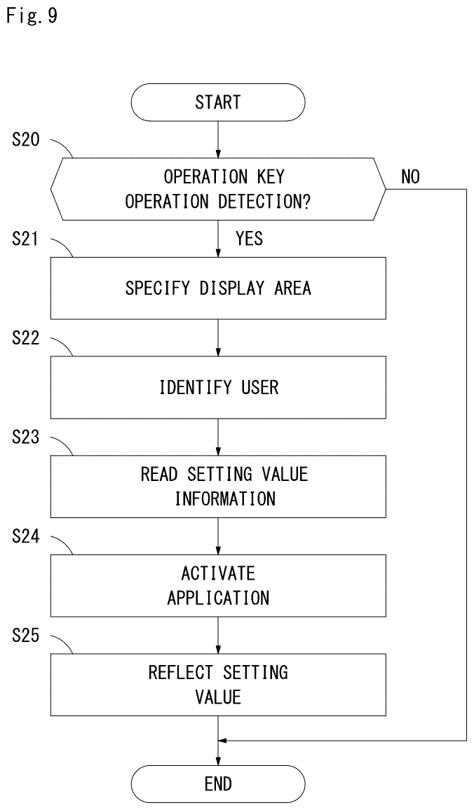

Next, FIG. 9 is a flowchart illustrating a processing procedure for automatically reflecting a setting value when a user uses the image processing apparatus 1. This process is performed by the functions of the setting reflection unit 36 and the application activation unit 37 in the setting management section 30.

When starting the processing of the flowchart illustrated in FIG. 9, the setting management section 30 determines whether an operation of any of the operation key 21 by the user has been detected (step S20). When the operation of the operation key 21 by the user is detected (YES in step S20), the setting management section 30 specifies the display area in which the operated operation key 21 is arranged (step S21). For example, the setting management section 30 specifies in which of the plurality of display areas 27 and 28 the operation key 21 is arranged.

The setting management section 30 identifies the user based on the identified display area (step S22). For example, when the operation key 21 operated by the user is arranged in the display area 27, the setting management section 30 specifies the user belonging to the company A. When the operation key 21 operated by the user is arranged in the display area 28, the setting management section 30 specifies the user who belongs to the company B.

The setting management section 30 reads the setting value information 17 from the storage section 13 (step S23). Next, the setting management section 30 reads a setting value corresponding to the identified user from the setting value information 17.

The setting management section 30 executes the application program 15 associated with the operation key 21 operated by the user, and activates an application for executing a job (step S24). When the application is activated, the setting management section 30 overwrites the setting value of each setting item of the application with the setting value read from the setting value information 17. That is, the setting management section 30 reflects the setting value previously specified by the user in the application (step S25). Therefore, when the start-up of the application is completed and the setting screen by the application is displayed on the display part 8a, the setting value designated in advance by the user is displayed as the initial value in each setting item of the setting screen. Therefore, the user does not need to change the setting value of each setting item from the default value of the application after the application is activated, and can efficiently perform the setting operation of the job.

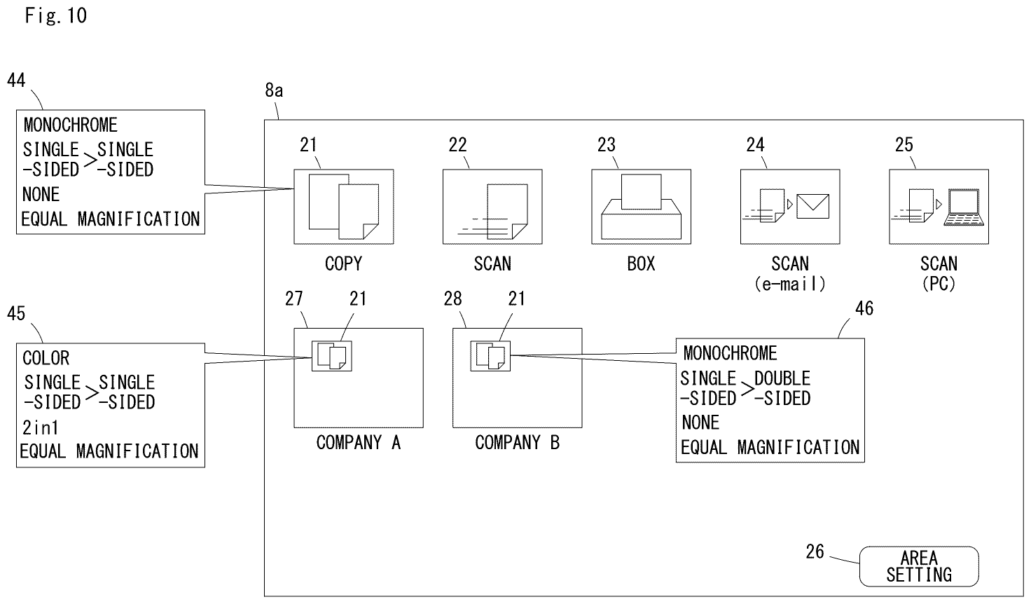

FIG. 10 is a diagram illustrating an example of initial values to be reflected in an application in response to the operation key 21 operated by the user. As illustrated in FIG. 10, the operation screen includes the original operation key 21, the operation key 21 arranged in the display area 27 of the company A, and the operation key 21 arranged in the display area 28 of the company B. These operation keys 21 are all operation keys for starting the same application program 15.

For example, when the user activates an application by operating the original operation key 21, the setting value 44 that are set as the default settings of the application are reflected in the application. When the user operates the operation key 21 arranged in the display area 27 of the company A to activate the application, the unique setting value 45 set in advance by the user of the company A is reflected in the application. Furthermore, when the user operates the operation key 21 arranged in the display area 28 of the company B to activate the application, the unique setting value 46 set in advance by the user of the company B is reflected in the application.

Therefore, when a user belonging to the company A tries to execute a job by using the image processing apparatus 1, the user can easily perform setting of the job by operating the operation keys 21 arranged in the display area 27. Furthermore, when a user belonging to the company B wants to use the image processing apparatus 1 to perform a job, the user can easily make settings for the job by operating the operation key 21 located in the display area 28.

In the above description, the case where the display part 8a displays folders as the plurality of display areas 27 and 28 allocated to each user has been exemplified. However, the plurality of display areas assigned to each user are not limited to those displayed as folders. For example, the plurality of display areas may be displayed as tab screens assigned to respective users.

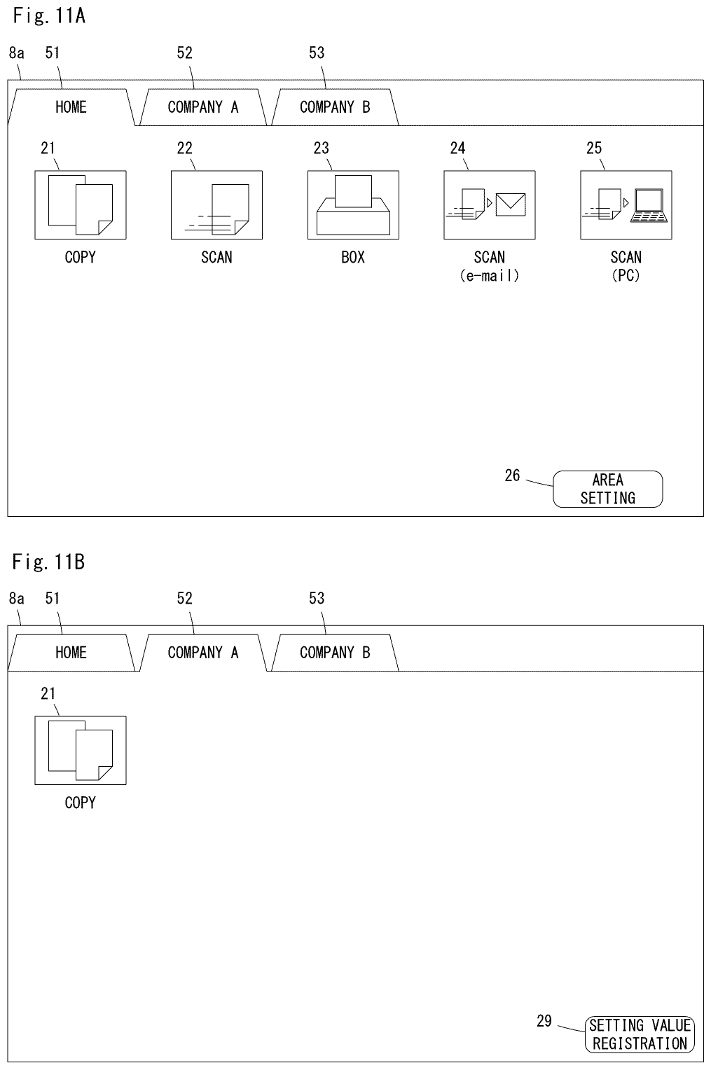

FIG. 11A and FIG. 11B are diagrams showing operation screens in which a plurality of display areas 51, 52, and 53 are set as tab screens. Three tab screens are set as display areas 51, 52, and 53 in the operation screen of FIG. 11A. The plurality of display areas 51, 52, and 53 can be switched and displayed on the display part 8a based on a user operation. In FIG. 11A, the display area 51 is displayed in full screen in the display part 8a. The display area 51 is a tab screen that is not assigned to a specific user, and is an operation screen corresponding to the above-described home screen (see FIG. 3). In contrast, the display area 52 is a tab screen allocated to users belonging to the company A. The user of the company A can displays the operation screen corresponding to the display area 52 on the display part 8a by selecting the tab corresponding to the display area 52. Furthermore, a display area 53 is a tab screen assigned to a user who belongs to a company B. The user of the company B can display the operation screen corresponding to the display area 53 on the display part 8a by selecting the tab corresponding to the display area 53.

FIG. 11B illustrates the operation screen on which the display area 52 of the company A is displayed. In the display area 52, operation keys 21 related to a copy job are arranged. A setting value registration key 29 is displayed in the display area 52. By operating the setting value registration key 29 in the display area 52, the user of the company A can register in advance a setting value to be automatically reflected when an application related to a copy job is activated by operating the operation key 21 in the display area 52. After registering the setting values, the user of the company A can easily set a job by operating the operation key 21 in the display area 52 when using the copy function of the image processing apparatus 1. Note that the same applies to a case where the user of the company B selects and displays the display area 53.

Therefore, the plurality of display areas assigned to each user are not limited to those displayed as folders, and may be those displayed as tab screens.

According to the image processing apparatus of the present embodiment, it becomes possible to reflect and display setting values and the like specific to each company or user with a relatively simple method, thus enhancing user convenience.

### Second Embodiment

Next, a second embodiment of the present invention will be described. In the present embodiment, additional functions that can be added to the basic functions described in the first embodiment will be described. Note that the hardware configuration of the image processing apparatus 1 in the present embodiment is the same as that described in the first embodiment.

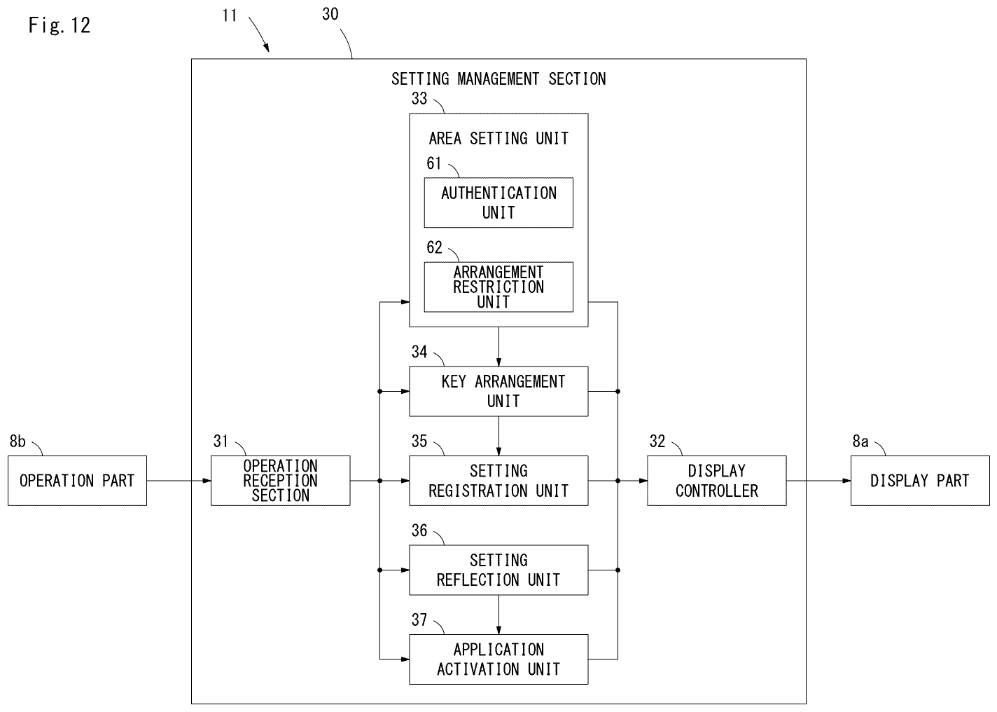

FIG. 12 is a block diagram illustrating an example of the detailed configuration of the setting management section 30 in the second embodiment. The setting management section 30 resides in the hardware processor 11 when the image processing apparatus 1 is powered on, as in the first embodiment. As in the first embodiment, the setting management section 30 of the present embodiment includes the operation reception section 31, the display controller 32, the area setting unit 33, the key arrangement unit 34, the setting registration unit 35, the setting reflection unit 36, and the application activation unit 37. The setting management section 30 illustrated in FIG. 12 is different from the setting management section 30 of the first embodiment in that the area setting unit 33 includes an authentication unit 61 and an arrangement restriction unit 62.

The authentication unit 61 sets an authentication password (authentication information) in each of the plurality of display areas 27 and 28 allocated to each user, and performs an authentication process when each of the display areas 27 and 28 is displayed in an enlarged manner. The authentication unit 61 functions when a new display area is created by the area setting unit 33. Then, the authentication unit 61 sets an authentication password in the new display area created by the area setting unit 33.

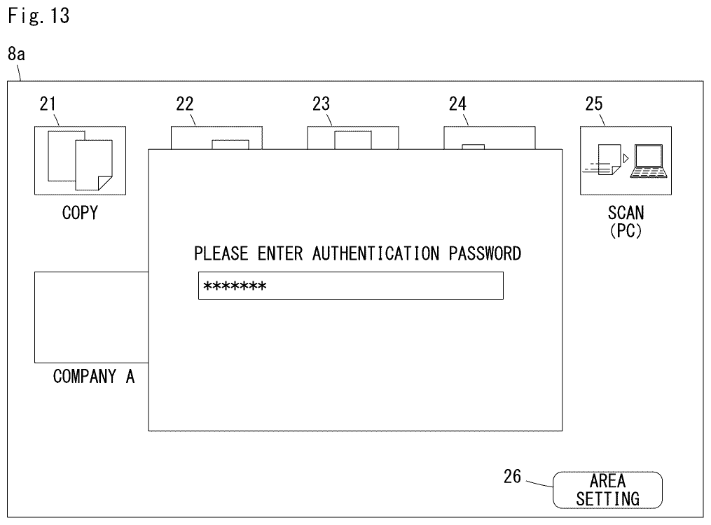

FIG. 13 is a diagram illustrating an example of a screen for setting an authentication password by the authentication unit 61. For example, when a new display area 27 is created by the user of the company A, the authentication unit 61 displays a password setting screen as shown in FIG. 13. The user of the company A sets an arbitrary password on the password setting screen. The authentication unit 61 stores the password set in the display area 27 by the user in association with the display area 27. Therefore, when the plurality of display areas 27 and 28 are created in the operation screen displayed on the display part 8a, different authentication passwords are set for the plurality of display areas 27 and 28, respectively.

In a case where an authentication password is set for each of the plurality of display areas, when enlargement display of any of the display areas is instructed by the user, the authentication unit 61 displays a password input screen on the display part 8a. Next, the authentication unit 61 performs authentication processing in which the password entered in the password entry screen is collated with the authentication password associated with the display area. When the authentication is successful in the authentication processing, the authentication unit 61 permits the display area specified by the user to be enlarged and displayed. As a result, the user can operate the operation key 21 arranged in the designated display area. In contrast, if authentication fails in the authentication processing, the authentication unit 61 prohibits the display area specified by the user from being enlarged and displayed. In this case, the user cannot operate the operation key 21 arranged in the designated display area.

In this way, the authentication unit 61 sets an authentication password in each of the plurality of display areas 27 and 28 allocated to each user. Then, the authentication unit 61 displays the operation key 21 included in each of the plurality of display areas 27 and 28 in a state in which the user can operate the operation key 21 on condition that a password matching the authentication password is input. Therefore, the image processing apparatus 1 can prevent the operation key 21 in the display area 28 assigned to the user of the company B from being operated by the user belonging to the company A. Further, the image processing apparatus 1 can prevent the user belonging to the company B from operating the operation key 21 in the display area 27 assigned to the user of the company A. That is, the image processing apparatus 1 can prevent the operation key 21 arranged in the display areas 27 and 28 allocated to the respective users from being used by other users. Thus, the convenience of the image processing apparatus 1 shared by a plurality of companies is further enhanced.

The arrangement restriction unit 62 restricts the arrangement of the operation key 21 in each of the plurality of display areas 27 and 28. For example, when the new display areas 27 and 28 are created by the area setting unit 33, the arrangement restriction unit 62 registers, based on a user operation, the operation key 21 that can be arranged in the new display areas 27 and 28. In addition, the arrangement restriction unit 62 may register the operation key 21 that is prohibited from being arranged in the new display areas 27 and 28. Next, when detecting a user's operation of arranging an operation key 21, the arrangement restriction unit 62 determines whether the arrangement of the specified operation key 21 is permitted or prohibited. When arrangement of the specified operation key 21 is permitted, the arrangement restriction unit 62 arranges the specified operation key 21 in the display areas 27 and 28 on the basis of the user's arrangement operation. On the other hand, when the arrangement of the designated operation key 21 is prohibited, the arrangement restriction unit 62 does not arrange the operation key 21 designated by the user in the display areas 27 and 28.

As described above, the arrangement restriction unit 62 restricts the arrangement of the operation key 21 in each of the plurality of display areas 27 and 28. Therefore, the image processing apparatus 1 can prevent the operation key 21 from being erroneously registered by the user of the company B in the display area 27 allocated to the user of the company A. Furthermore, the image processing apparatus 1 can prevent the operation key 21 from being erroneously registered by the user of the company A in the display area 28 assigned to the user of the company B.

Note that the configuration and operation of the present embodiment other than those described above are the same as those described in the first embodiment.

### Third Embodiment

Next, a third embodiment of the present invention will be described. In the present embodiment, additional functions that can be further added to the functions described in the first embodiment and the second embodiment will be described. Note that the hardware configuration of the image processing apparatus 1 in the present embodiment is the same as that described in the first embodiment.

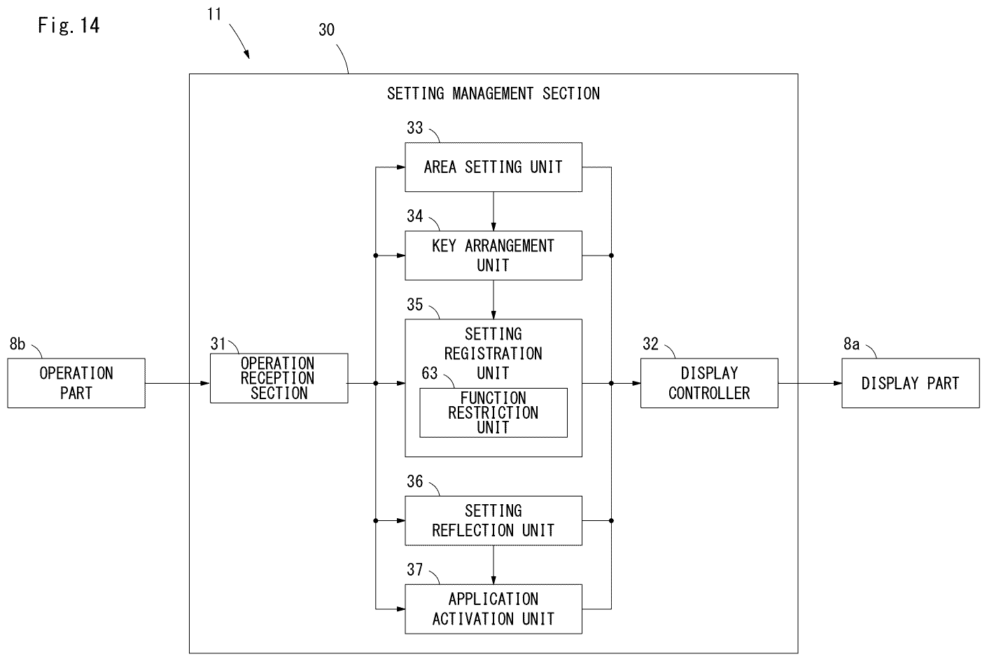

FIG. 14 is a block diagram illustrating an example of the detailed configuration of the setting management section 30 in the third embodiment. The setting management section 30 resides in the hardware processor 11 when the image processing apparatus 1 is powered on, as in the first embodiment. As in the first embodiment, the setting management section 30 of the present embodiment includes the operation reception section 31, the display controller 32, the area setting unit 33, the key arrangement unit 34, the setting registration unit 35, the setting reflection unit 36, and the application activation unit 37. The setting management section 30 illustrated in FIG. 14 is different from the setting management section 30 of the first embodiment in that the setting registration unit 35 includes a function restriction unit 63.

When a unique setting value is registered for each of the operation key 21 arranged in the display areas 27 and 28, the function restriction unit 63 imposes a limitation on a setting value that can be changed by the user for a setting item to be applied to a job. For example, a user may select “monochrome” as an initial value for a color setting item to be applied to a copy job. In that case, when the application of the copy job is activated, “monochrome” is displayed as an initial value for the setting item of color. However, the initial value can be appropriately changed by the user. Therefore, the user can change the color setting item from “monochrome”, which is the initial value, to “color” by operating the pull-down key 41 on the copy setting screen after the application is activated. The function restriction unit 63 imposes a limitation on such an operation of changing the setting value by the user. For example, the function restriction unit 63 excludes “color” in the setting item of color from the setting values selectable by the user. As a result, the copy setting screen is displayed after the activation of the application, and even in a case where the user has operated the pull-down key 41, the setting value of “color” is grayed-down and displayed in a manner such that the user cannot select. That is, the function restriction unit 63 imposes a display restriction on a group of setting values that can be set for a setting item applied to a job on a user basis and imposes a setting change restriction on the group of setting values on a user basis.

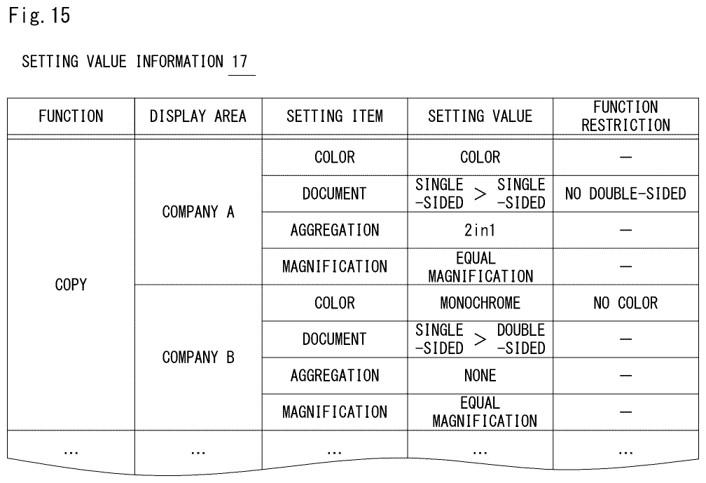

Upon imposing a restriction on a setting item to be applied to a job on the basis of a user's instruction operation, the function restriction unit 63 records the function restriction in the setting value information 17. FIG. 15 is a diagram illustrating an example of the setting value information 17 to which an item of function restriction is added. In the setting value information 17 illustrated in FIG. 15, duplex printing is set for the setting item for a document to be applied in a case where the operation key 21 arranged in the display area 27 used by the user of the company A is operated. Further, in the setting value information 17 illustrated in FIG. 15, “color unavailable” is set in the setting item of the color to be applied when the operation key 21 arranged in the display area 28 used by the user of the company B is operated.

After reflecting the setting value of the setting item to be applied to the job at the time of starting the application, the setting reflection unit 36 restricts the setting change operation by the user to the setting value within the range restricted by the function restriction unit 63. At this time, the setting reflection unit 36 refers to the setting value information 17 illustrated in FIG. 15 and restricts a range in which the user can change the setting. Therefore, for example, the user of the company A cannot change the initial values of the setting items of the document to the setting values of “single-sided [symbol] double-sided” and “double-sided [symbol] double-sided” when performing the setting operation of the copy job after activating the application. For example, when the user of the company B performs the setting operation of the copy job, the user cannot change the initial value of the setting item of the color to the setting value of “color”. Therefore, even after the application is activated, the user can change the setting only within the range of the setting value limited by the function restriction unit 63. In a case where a change to a setting value other than the setting value designated as the initial value is prohibited, the setting reflection unit 36 may not permit the change of the setting value reflected in the application as the initial value at the time of activation of the application.

The function restriction unit 63 can also impose a display restriction when displaying an external destination such as an electronic mail. The destination information to the outside is managed by the application. The function restriction unit 63 imposes a display restriction on such destination information.

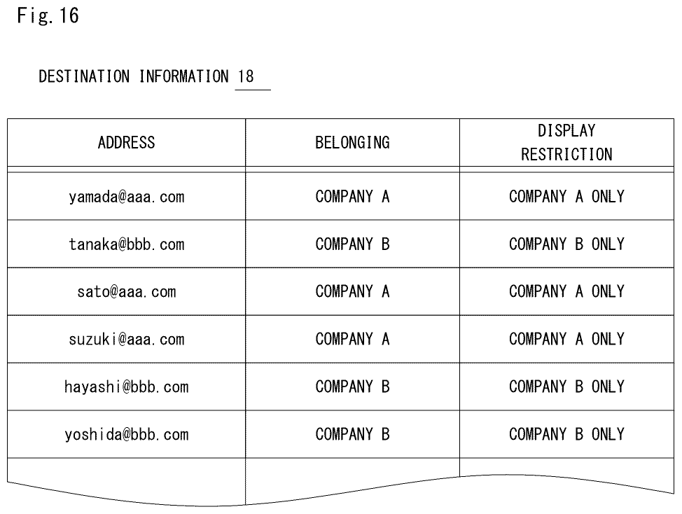

FIG. 16 is a diagram showing an example of the destination information 18 to which the display restriction is applied. Destination information 18 illustrated in FIG. 16 indicates information managed by an application that executes processing of attaching image data generated by a scan job to an e-mail and transmitting the e-mail to the outside. e-mail addresses registered by users of the company A and the company B are registered in the destination information 18. If all the e-mail addresses registered by the users of the company A and the company B are displayed when this application is activated, a wrong e-mail address may be selected as the destination of the image data.

Therefore, the function restriction unit 63 imposes a display restriction on the destination information 18 in order to restrict the display of the e-mail addresses of the users belonging to the company A to only the users belonging to the company A. Furthermore, the function restriction unit 63 imposes a display restriction on the destination information 18 in order to restrict the display of the email addresses of the users belonging to the company B to only the users belonging to the company B. When reading the destination information 18 and displaying the destination list, the application refers to the display restriction given to the destination information 18, and displays the destination list based on the display restriction.

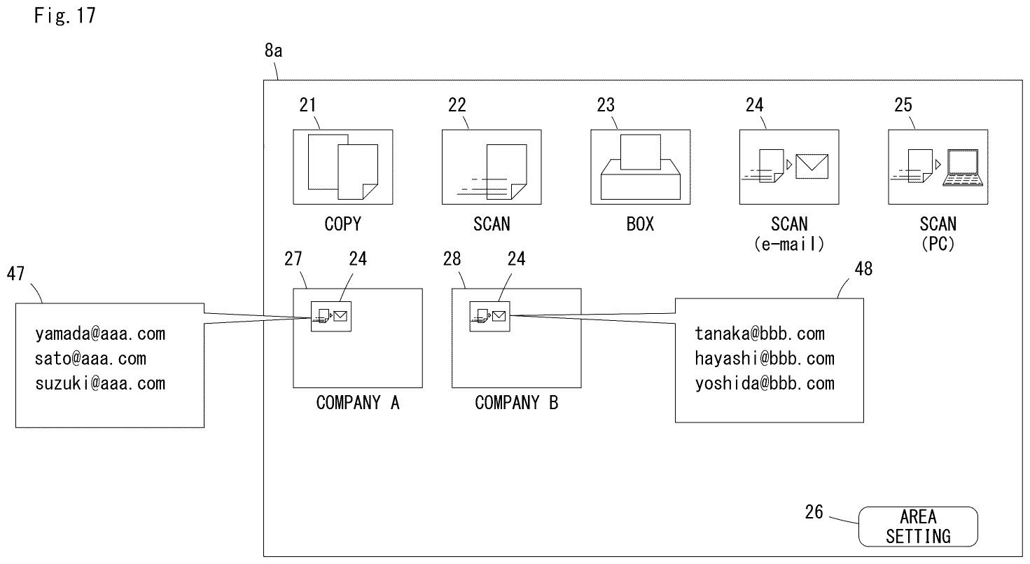

FIG. 17 is a diagram illustrating a display example of a destination list that changes in accordance with the operation key 24 operated by the user. As illustrated in FIG. 17, for example, when the user operates the operation key 24 located in the display area 27 for company A to activate the application, the application reads, from the destination information 18, destinations whose display objects are limited to users belonging to company A. As a result, the destination list 47 illustrated in FIG. 17 is displayed on the display part 8a. Further, for example, when the user operates the operation key 24 arranged in the display area 28 of the company B to activate the application, the application reads, from the destination information 18, destinations whose display targets are limited to only the users belonging to the company B. As a result, the destination list 48 illustrated in FIG. 17 is displayed on the display part 8a.

As described above, the function restriction unit 63 imposes the display restriction on the destination information 18, thereby preventing all the e-mail addresses from being displayed for the users of the company A and the company B. As a result, the image processing apparatus 1 can reduce the possibility that the user selects a wrong e-mail address.

The configuration and operation of the present embodiment other than those described above are the same as those described in the first embodiment or the second embodiment.

### Modification Examples

A preferred embodiment of the present invention has been described above. However, the present invention is not limited to the content described in the above embodiment, and various modification examples are applicable.

For example, in the above-described embodiment, the case where the image processing apparatus 1 is configured as an MFP has been exemplified. However, the image processing apparatus 1 is not limited to one configured as an MFP. For example, the image processing apparatus 1 may be a printer having only a print function. Furthermore, the image processing apparatus 1 may be an apparatus that is connected to a network and transmits and receives image data. Furthermore, the image processing apparatus 1 may be an apparatus other than those described above.

The image processing apparatus 1 described in the above embodiment customizes a setting value applied to a job for each user and reflects the setting value as an initial value at the time of starting an application. Such setting values may include a setting value related to network connection of the image processing apparatus 1. For example, when using the image processing apparatus 1, a user belonging to the company A may register, as an initial value, a setting value for disabling network connection. In this case, when the user of the company A enlarges the display area 27 and operates the operation key 21 arranged in the display area 27, the image processing apparatus 1 executes a job with the network connection disabled. Therefore, for example, when the image processing apparatus 1 is used by a user of a company A, information is not leaked to the outside via a network. Therefore, the image processing apparatus 1 can prevent the user belonging to the company A from leaking information to the outside.

Furthermore, in the above embodiment, it has been described that the plurality of application programs 15 include a plurality of programs that use the same function of the image processing apparatus 1. For example, the plurality of application programs 15 for performing different jobs on image data generated by a scan job may be installed in the image processing apparatus 1. In such a case, mutually common setting values can be applied to the setting items of the scan job common to the plurality of jobs. Therefore, it is preferable that the setting registration unit 35 integrally manage the setting values of the setting items common to the plurality of jobs, instead of separately managing the setting values of the setting items common to the plurality of jobs using the same function. By integrating and managing the setting values of the setting items common to the plurality of jobs, there is an advantage that the information amount of the setting value information 17 can be reduced.

In the above-described embodiment, the control program 16 is stored in advance in the storage section 13 of the image processing apparatus 1. However, the control program 16 is not limited to a program stored in the storage section 13 in advance. In other words, the control program 16 can be an object of transaction by itself. Therefore, the control program 16 may be provided in a state of being recorded on a non-transitory computer-readable recording medium. Furthermore, the control program 16 may be provided in a downloadable manner via a network such as the Internet.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus, comprising:
a hardware processor; and
a display part that displays a plurality of display areas assigned to respective users, and arranges and displays operation keys associated with jobs in the respective display areas, wherein
the hardware processor registers and manages, for each user, a setting value of a setting item to be applied to a job, and
when the operation key in any one of the plurality of display areas is operated, the hardware processor identifies a user based on the display area in which the operation key is operated, reads the setting value registered for the identified user, and reflects the setting value as an initial value of the setting item to be applied to the job.

2. The image processing apparatus according to claim 1, wherein
the setting value of the setting item to be applied to the job is selectable from a group of setting values including a plurality of setting values, and
the hardware processor registers and manages, for each user, a pre-specified setting value from the group of setting values.

3. The image processing apparatus according to claim 1, wherein
the operation key is an operation key associated with a copy job or a scan job.

4. The image processing apparatus according to claim 1, wherein
the display part displays, as the plurality of display areas, a plurality of folders assigned to respective users.

5. The image processing apparatus according to claim 1, wherein
the display part displays, as the plurality of display areas, a plurality of tab screens assigned to respective users.

6. The image processing apparatus according to claim 1, wherein
the hardware processor integrates and manages setting values of setting items common to a plurality of jobs using the same function.

7. The image processing apparatus according to claim 2, wherein
the operation key is an operation key for activating an application for executing the job, and
when the application is activated by the operation of the operation key, the hardware processor reflects the setting value as an initial value of the setting item applied to the application.

8. The image processing apparatus according to claim 7, wherein
the hardware processor does not permit the application to change the setting value after reflecting the setting value of the setting item applied to the application.

9. The image processing apparatus according to claim 8, wherein
the setting value includes a setting for disabling network connection.

10. The image processing apparatus according to claim 2, wherein
the hardware processor imposes, on each of a plurality of setting values included in the group of setting values, a limitation on a setting change for each user.

11. The image processing apparatus according to claim 2, wherein
the hardware processor imposes, for each user, a display restriction on each of a plurality of setting values included in the group of setting values.

12. The image processing apparatus according to claim 1, wherein
the hardware processor sets, for each user, an arrangement limitation for the operation keys in each of the plurality of display areas, and
the display part does not arrange the operation keys in the display area for which the arrangement limitation is set by the hardware processor.

13. The image processing apparatus according to claim 1, wherein
the hardware processor sets an authentication password for each of the plurality of display areas, and
allows the operation keys included in each of the plurality of display areas to be displayed on condition that the authentication password is input.

14. A control method for controlling an image processing apparatus having a display part, the control method comprising:
registering and managing, for each user, a setting value of a setting item to be applied to a job; and
displaying, on the display part, a plurality of display areas assigned to respective users and operation keys associated with respective jobs in the respective display areas, wherein
when the operation key in any one of the plurality of display areas is operated, the control method identifies a user based on the display area in which the operation key is operated, reads the setting value registered for the identified user, and reflects the setting value as an initial value of the setting item to be applied to the job.

15. The control method according to claim 14, wherein
the setting value of the setting item to be applied to the job is selectable from a group of setting values including a plurality of setting values, and
the control method includes registering and managing, for each user, a pre-specified setting value from the group of setting values.

16. The control method according to claim 15, wherein
the operation key is an operation key for activating an application for executing the job, and
the control method reflects, when the application is activated by an operation of the operation key, the setting value as an initial value of the setting item to be applied to the application.

17. A non-transitory computer-readable recording medium storing a program to be executed by a hardware processor of an image processing apparatus comprising a display part, the program causing the hardware processor to perform:
registering and managing, for each user, a setting value of a setting item to be applied to a job;
displaying, on the display part, a plurality of display areas assigned to respective users and operation keys associated with respective jobs in the respective display areas; and
identifying, when the operation key in one of the plurality of display areas is operated, a user based on the display area in which the operation key is operated, reads the setting value registered for the identified user, and reflects the setting value as an initial value of the setting item to be applied to the job.

18. The non-transitory computer-readable recording medium according to claim 17, wherein
the setting value of the setting item to be applied to the job is selectable from a group of setting values including a plurality of setting values, and
the program causes the hardware processor to perform registering and managing, for each user, a pre-specified setting value from the group of setting values.

19. The non-transitory computer-readable recording medium according to claim 17, wherein
the operation key is an operation key for activating an application for executing the job, and
the program causes the hardware processor to perform reflecting the setting value as an initial value of the setting item applied to the application when the application is activated by an operation of the operation key.
